(19) United States
(12) Patent Application Publication
(10) Pub. No.: US 2003/0036959 A1
(43) Pub. Date: Feb. 20, 2003

(54) Method for providing advertisement information

(76) Inventor: Ryo Takahashi, Osaka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/220,645

(22) PCT Filed: Jun. 27, 2001
(86) PCT No.: PCT/JP01/05519

(51) Int. Cl. G06F 17/60

(52) U.S. Cl. 705/14

(57) ABSTRACT

Described is a method for providing advertisement information, according to which a potential owner of a free hosting service can run the service easily. The Web pages of users whom the owner has recruited contain the banner advertisement 8a designated by the system manager who manages the computer system for the free hosting system, in addition to the banner advertisement 8b designated by the owner, which allows both the owner and the system manager to gain advertisement income. This can relieve the owner of troublesome operations including management of the computer system and can concentrate his or her management resources on business of his or her line such as user recruiting.

### TECHNICAL FIELD

The present invention relates to a method for providing advertisement information on computer networks typified by the Internet, and more specifically, to a method for providing advertisement information according to which users can run a free hosting service in return for placing advertisement on their Web pages.

### BACKGROUND ART

In recent years, with increasing technical innovation and penetration of personal computers, more and more information has come to be sent out on the Internet, and particularly on Web pages.

Publication of Web pages on the Internet is sometimes carried out by the senders of information by means of their own computer systems that are composed of a high-performing server, a high-speed communications circuit of continuous connection, a router, and the like.

However, these computer systems are expensive and require high techniques to be operated. Therefore, the senders of information (users) often borrow a part of the storage region of a storing device provided in the server computer, that is, make use of a so-called hosting service so as to make their Web pages available for general use.

On the other hand, the contents of Web pages often limit viewers in terms of occupation, age, residential area, hobby, and the like, which enables advertisements (banner advertisements and so on) to be placed on frequently-viewed Web pages so as to narrow down target viewers for efficient advertising activities. For this reason, frequently-viewed Web pages are worth placing advertisements, and more and more banner advertisements have been placed.

With this trend, free hosting services have been popular in recent years. The free hosting service means that the provider of a service (the owner) lends, free of charge, a user who generates a Web page a storage region of the server computer connected on the Internet, and in return, the owner places a banner or other advertisement on the user's Web page stored in the above-mentioned storage region and receives profits by advertisement fee from the advertiser.

In order to provide the above conventional free hosting service, the owner must do the following by himself/herself: (1) maintenance of the server computer, (2) domain acquisition, (3) management of the system including the communications circuit and the router, (4) generation of the contents (Web page, banner advertisement and so on), (5) advertisement for the hosting service, promotion of a user invitation and the like, and (6) support services for users. This makes it difficult for privates and medium-sized and smaller companies to provide such a service, because of their insufficient manpower and financial resources.

In view of these problems, the present invention provides a method for providing advertisement information which enables the owner to start a free hosting service easily by leaving the above-mentioned tasks (1)-(3) requiring high technical knowledge to a system manager who knows the computer system well, and which also enables both the owner and the system manager to obtain advertisement income by placing the advertisement designated by the system manager (advertisement fee becomes the system manager's income) as well as the advertisement designated by the owner (advertisement fee becomes the owner's income) on the user's Web page.

### DISCLOSURE OF THE INVENTION

The method for providing advertisement information according to the present invention is a method for providing advertisement information through a free hosting service which places advertisement information on the Web page of a user in return for lending, free of charge, the user a storage region of a server computer, which is connected on the Internet and stores Web page information, the method including: placing, on the Web page, advertisement information designated by a system manager who manages a computer system including the above server computer, in addition to advertisement information designated by an owner who runs the above free hosting service. The term advertisement information mentioned in this case indicates banner advertisement, text advertisement and the like that are displayed on Web pages.

The above-mentioned advertisement information can be placed on direct mail and distributed to users in addition that placing on their Web pages.

As described above, the system manger takes the place of the owner to manage the computer system such as the server that is used for a free hosting service. This enables both the owner and the system manager to concentrate their managerial resources on their own lines, thereby running their businesses efficiently.

### BRIEF DESCRIPTION OF THE DRAWINGS

FIG. 1 is a block diagram showing the structure of an advertisement system for carrying out the method for providing advertisement information according to the present invention.

FIG. 2 is a sample screen structure of the “application page”.

FIG. 3 is a sample screen structure of the “invitation page”.

FIG. 4 is a sample screen structure of the “registration page”.

FIG. 5 is an example of the “e-mail”.

FIG. 6 is a sample screen structure of the “authentication page”.

FIG. 7 is a sample screen structure of the “file resignation page”.

FIG. 8 is a sample screen structure of the “Web page”.

FIGS. 9, 10, and 11 are other sample screen structures of the “Web page”.

### BEST MODE FOR CARRYING OUT THE INVENTION

The embodiment of the present invention will be described as follows based on the drawings.

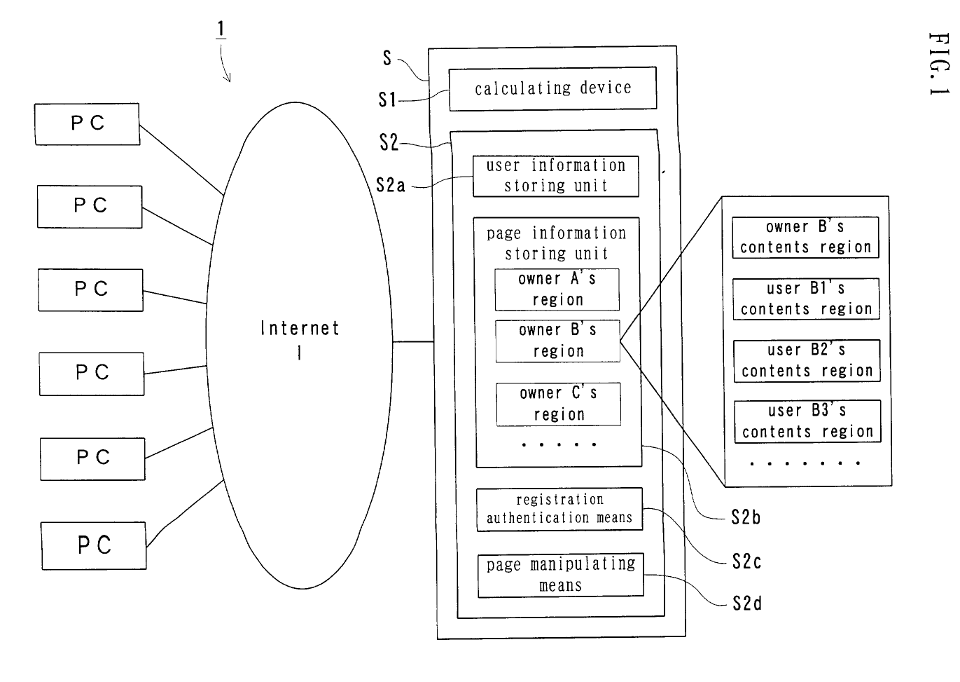

FIG. 1 is a block diagram showing the structure of an advertisement system 1 (hereinafter referred to as the system) for realizing the method for providing advertisement information according to the present invention. The system 1 enables the system manager, the owner, and the user to provide Web-page viewers with advertisement information placed on Web pages containing various kinds of information thereon.

As shown in FIG. 1 the system 1 is composed of a server computer S(hereinafter simply referred to as the server) and plural terminal PCs used by the owners, the users, and Web-page viewers and the like. And the server S and the terminal PCs are connected to each other on the Internet I.

The terminal PCs have a WWW browsing function (a browser), which allows the data stored in the server S to be browsed or printed through the Internet I, and which also allows a new data to be entered and stored in the server S. The terminal PCs are each provided with various means that ordinary PCs have, such as means for displaying a data on the monitor and means for connecting on the Internet I.

The server S is equipped with a calculating device S1 for performing various calculations and a storing device S2 for storing various kinds of information and the like. The storing device S2 is also provided with a various-information storing unit for storing information in the form of list and different means used for information processes and the like, which will be detailed below.

The term “means” referred to in this specification indicates programs stored in an executable form. The server S includes various other means that any ordinary server has, such as means for displaying data on the monitor, means for connecting on the Internet, and means for transmitting Web pages, in addition to the each information storing units and means, which are described below. The server S further has other hardware components that any ordinary server computer has, such as a monitor and a keyboard, which are not illustrated.

A user information storing unit S2a stores in tabular form for each user, information about authentication including the IDs and passwords of the owners and the users who use the system 1, information about pages including the URLs of the Web pages managed by the owners and the users, and information about the users' attributions including their names, addresses, and phone numbers.

A page information storing unit S2b stores page information including Web page information which is stored by users and is in the form of HTML file or JPEG file and banner advertisement information. As shown in FIG. 1, the page information storing unit S2b is divided into plural storage regions assigned to the respective owners, and the page information of the respective users is stored in the storage regions assigned to the respective owners.

A registration authentication means S2c performs authentication of the owners and the users who are going to use the server S by providing them with IDs and passwords, thereby preventing the usage of frauds.

A page manipulating means S2d transmits page information stored in the page information storing unit S2b to a terminal PC on request from the terminal PC, or receives various kinds of file (HTML, JPEG, and the like) which structure page information from a terminal PC and stores it in the specific storage region assigned to each user.

The operations for the system 1 thus structured to provide advertisement information will be described as follows by being divided into (1) owner registration, (2) user registration and page information registration, (3) advertisement insertion, and (4) information browsing.

(1) Owner Registration

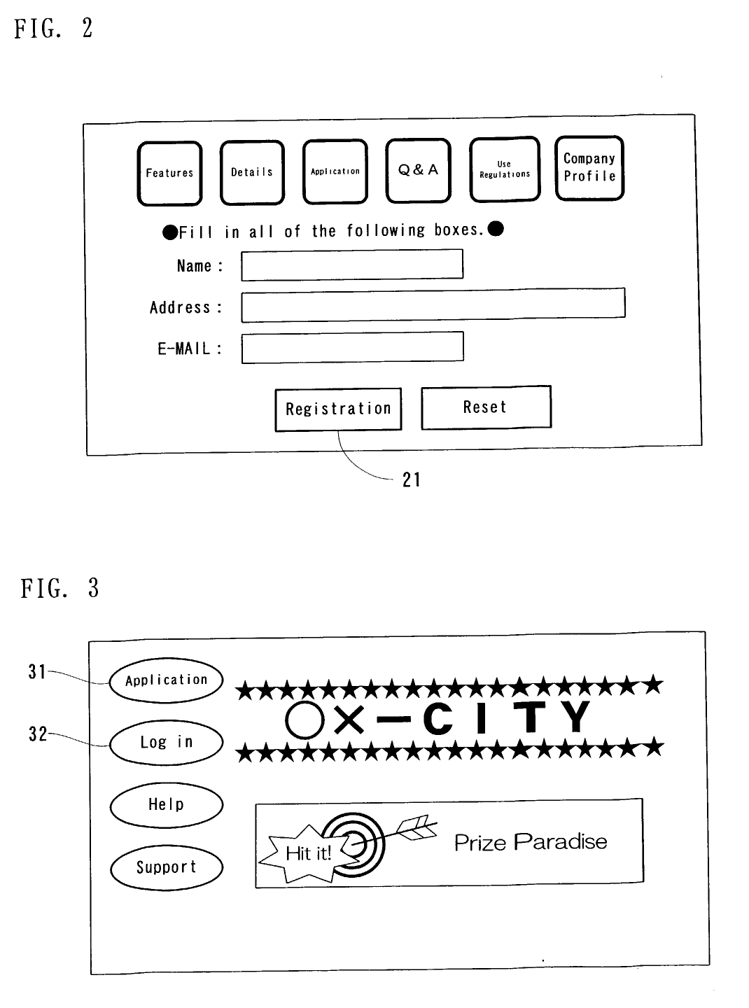

First of all, a potential owner accesses the server S from his or her own terminal PC; enters necessary data on the application page (refer to FIG. 2) provided by the system manager; and clicks on the “registration” button 21 to apply for the free hosting service run by the system manager. As the result, the entered contents are sent to the system manager via an e-mail or other methods.

Next, the system manager checks the contents of the application, and if he or she decides to authorize the application, an ID and a password to access the server S are sent to the owner.

The owner whose application has been permitted generates an HTML or a JPEG file necessary to run the free hosting service on his or her own terminal PC; uploads and stores the generated file to the page information storing unit S2b of the server S by means of FTP or CGI; and makes the invitation page (refer to FIG. 3) for inviting potential users available for general use.

After the completion of the publication, the owner recruits potential users and also solicits advertisements through magazine advertisement or ML.

(2) User Registration and Page Information Registration

First of all, a potential user accesses the server S from his or her own terminal PC and clicks on the “application” button 31 on the invitation page (refer to FIG. 3), which displays the registration page (refer to FIG. 4) on the monitor of the terminal PC.

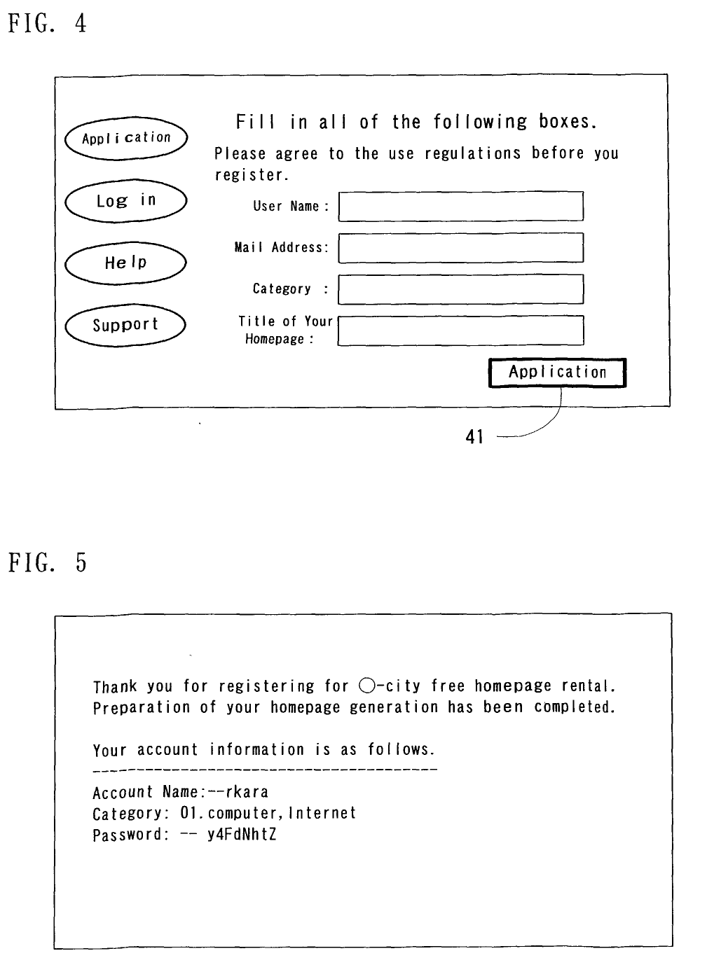

Then, the potential user enters necessary data on the registration page (refer to FIG. 4) and clicks on the “application” button 41 on the registration page, which allows the user to receive an ID and a password necessary to access the server S by an e-mail (refer to FIG. 5).

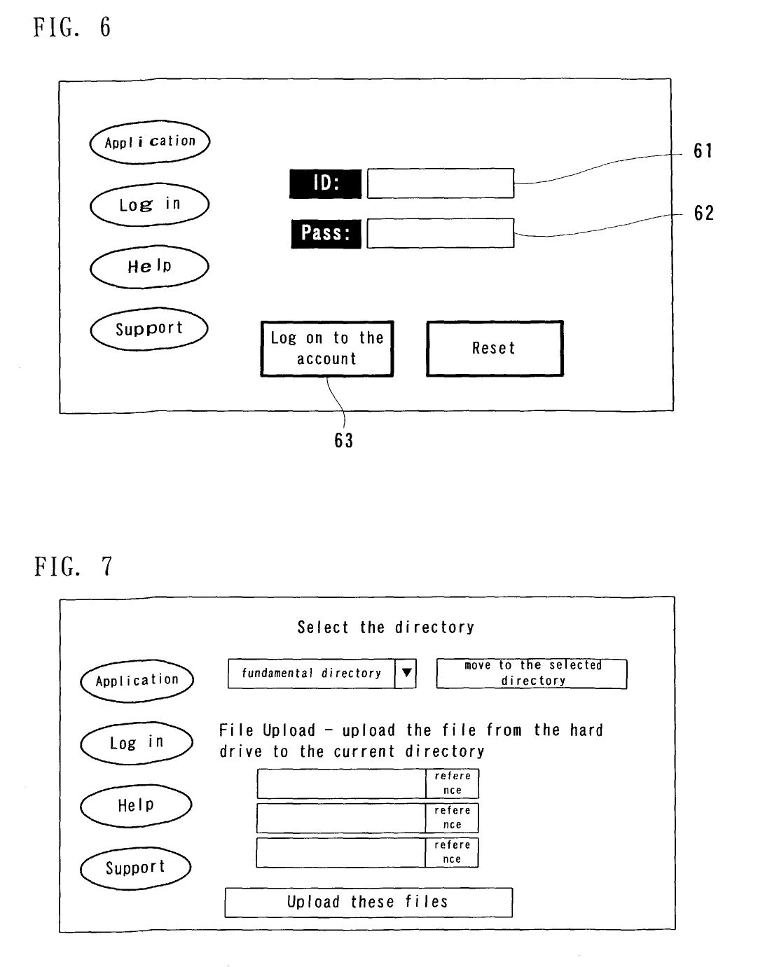

On receiving the e-mail (refer to FIG. 5), the user generates an HTML or a JPEG file necessary for the publication of the Web page by his or her own terminal PC, accesses the server S, and clicks on the “log in” button 32 on the invitation page (refer to FIG. 3), thereby displaying the authentication page (refer to FIG. 6).

Finally, the user inputs his or her ID and password on an ID box 61 and a password box 62 on the authentication page (refer to FIG. 6), and clicks on the “log on to the account” button 63, which allows the server S to perform authentication and to provide a file registration screen (refer to FIG. 7). Then, the user uploads and stores a file generated with CGI to the page information storing unit S2b of the server S. Various kinds of file can be uploaded by FTP, not through the file registration screen (refer to FIG. 7).

(3) Advertisement Insertion

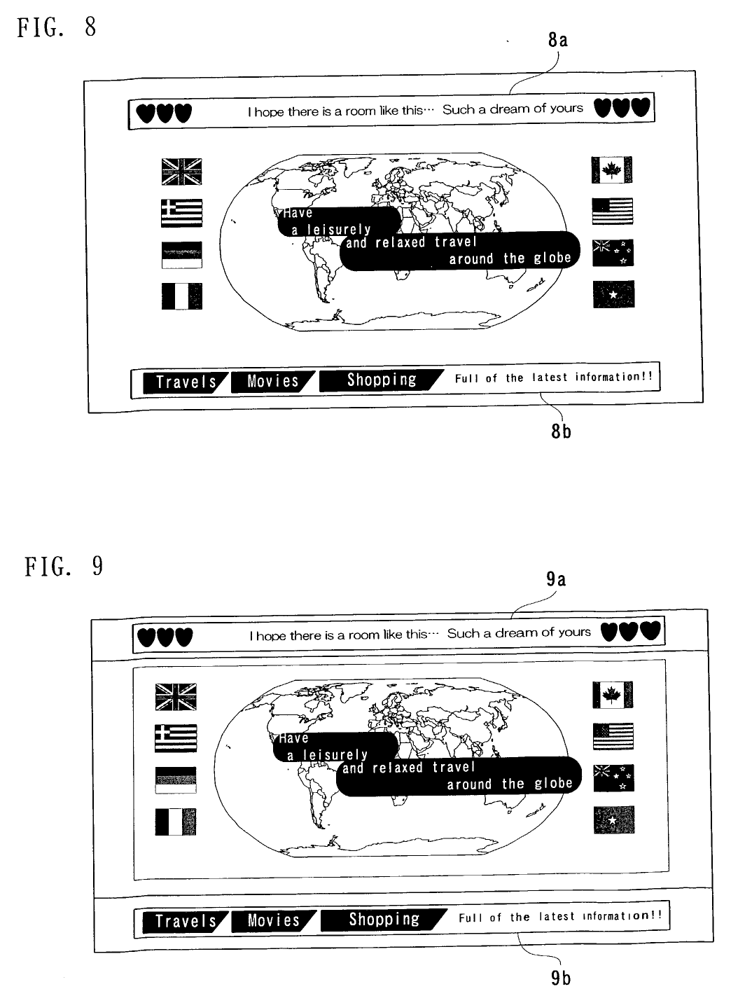

The owner and the system manager write HTML sentences for placing a banner advertisement on the HTML file which is stored, and uploads an image file for banner advertisement so as to make the banner advertisements 8a, 8b be displayed on the Web page (refer to FIG. 8). Alternatively, it is also possible to make use of the frame function of the HTML language to automatically display banner advertisements 9a, 9b on the Web page of the user (refer to FIG. 9).

(4) Information Browsing

Storing the page information and the advertisement information composing the Web page in the server S allows viewers to browse the Web page in the same manner as to browse normal Web pages, and as the result, the banner advertisements can be viewed together with the Web page.

As described hereinbefore, a free hosting system can be executed easily by making the system manager to take the place of the owner about highly technical matters including system management. In addition, the user's Web page which is made available for general use contains two kinds of advertisement: the advertisement by the system manager and the advertisement by the owner. This allows both the owner and the system manager to receive advertisement fee from the advertiser, thereby both making a profit from advertisement.

This invention is not restricted to the above embodiment and can be modified variously within the technical scope described in the claims.

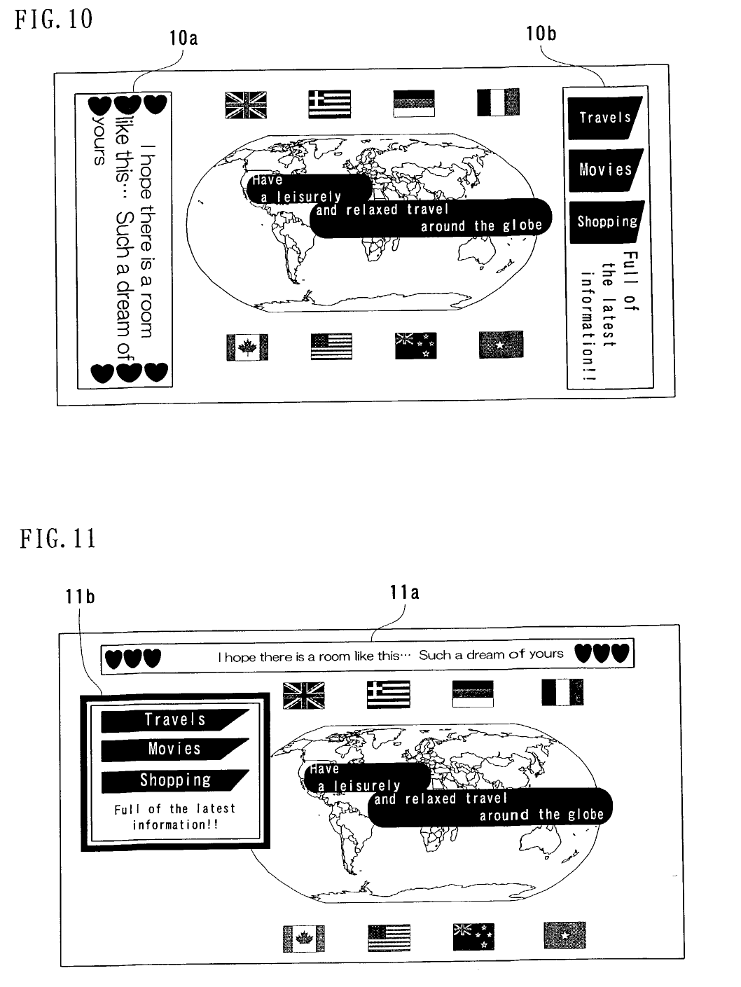

For one thing, banner advertisements are placed on the top and bottom of a Web page in the above embodiment; however, it can be placed in other areas as shown in FIG. 10 where banner advertisements 10a, 10b are placed at the right-side end or the left-side end, respectively. Alternatively, advertisement can be displayed in another window like the banner advertisement 11b shown in FIG. 11.

In addition to the advertisements designated by the owner and the system manger, the user can place another banner advertisement on his or her Web page.

Besides the above case where the system manager and the owner make profits by placing the banner advertisements designated by the system manager and the owner on the user's Web page as in the above embodiment, there are following cases: (a) instead of deleting advertisement information of the system manager and/or the owner, the system manager and/or the owner transmit(s) a direct mail containing advertisement information to each user and receive(s) advertisement rate; (b) only the advertisement designated by the system manager is placed and only the system manager receives advertisement income; and (c) additional fee is charged from the user if he or she wants to add hosting resources such as usable domain name range or disk capacity.

Furthermore, the terminals can be special-purpose terminals, game machines, portable PDAs or the like other than personal computers, and the storing units and means in the server S can be dispersedly arranged on plural computers.

### INDUSTRIAL APPLICABILITY

According to the method for providing advertisement information of the present invention, a potential owner can start a free hosting service easily by leaving highly technical matters to the system manager. Furthermore, both the owner and the system manager can obtain advertisement fee by placing the advertisement designated by the system manager as well as the advertisement designated by the owner on the user's Web page which is made available to general use.

1. A method for providing advertisement information through a free hosting service which places advertisement information on the Web page of a user in return for lending, free of charge, the user a storage region of a server computer, which is connected on the Internet and stores Web page information, said method comprising:
placing, on the Web page, advertisement information designated by a system manager who manages a computer system including said server computer, in addition to advertisement information designated by an owner who runs said free hosting service.

2. The method for providing advertisement information according to claim 1, wherein a system manager and/or an owner transmit(s) a direct mail containing advertisement information to each user instead of deleting advertisement information of the system manager and/or the owner.
